(19) United States
(12) Patent Application Publication
(10) Pub. No.: US 2011/0192803 A1
(43) Pub. Date: Aug. 11, 2011

(54) Apparatus for treating a cooling and rinsing fluid and control method for a treatment apparatus

(75) Inventors: Georg Holzmeier, Untermeitingen (DE); Marc Schuster, Karlsruhe (DE); Andreas Burkhard, Schwabmuenchen (DE)

(73) Assignee: Hilti Aktiengesellschaft, Schaan (LI)

(21) Appl. No.: 12/928,706

(22) Filed: Dec. 17, 2010

(30) Foreign Application Priority Data
Dec. 18, 2009 (DE) DE 102009054963.3

(51) Int. Cl. B01D 21/30; B01D 21/00

(52) U.S. Cl. 210/741; 210/97

(57) ABSTRACT

An apparatus (2) for treating a cooling and rinsing fluid stemming from a soiled drilling fluid (15), including a first container (20) that collects the soiled drilling fluid (15), a second container (21) that is connected to a discharge line (38) for the treated cooling and rinsing fluid (36), a pressure switch (41) that is arranged in the discharge line (38) for purposes of measuring the pressure, and a control unit (40) for switching the treatment apparatus (2) over between a first mode of operation and at least one other mode of operation, whereby the treatment apparatus (2) can be switched over between the first and the at least one other mode of operation as a function of the pressure measured in the discharge line (38).

This claims the benefit of German Patent Application No. DE 10 2009 054 963.3, filed Dec. 18, 2009 and hereby incorporated by reference herein.

The present invention relates to an apparatus for treating a cooling and rinsing fluid, as well as to a method for controlling a treatment apparatus.

### BACKGROUND

In abrasive and eroding work with diamond-tipped tools, for example, in the form of diamond core bits or diamond saws, it is necessary to cool the diamond-tipped tool in the vicinity of the working site in order to avoid damage to the diamond-tipped tool due to overheating. The cutting segments of the diamond-tipped tools are cooled by means of a cooling fluid during the work in order to assist the work procedures and increase the service life of the cutting segments. The fluid also serves to remove the solids abraded by the diamond-tipped tool from the working site. The supplied fluid is referred to as the cooling and rinsing fluid while the fluid laden with solids is referred to as the soiled drilling fluid.

European patent specification EP 0 941 828 B1 discloses a prior-art treatment apparatus for treating a cooling and rinsing fluid stemming from a soiled drilling fluid and for feeding the treated cooling and rinsing fluid to a power tool, for example, a core drill. The treatment apparatus comprises two air-tight and liquid-tight containers. During actual operation, the first container is operated as a negative-pressure tank by means of a negative-pressure device, while the second container is operated as an excess-pressure tank by means of an excess-pressure device. The negative-pressure tank is connected to the excess-pressure tank via a connecting line. A filter element is arranged on the lid of the excess-pressure tank. Due to the excess pressure, the pre-cleaned soiled drilling fluid flows into the interior of the filter element. Solids present in the pre-cleaned soiled drilling fluid are captured by the filter element. Recycled cooling and rinsing fluid collects in the interior of the filter element and can be fed to the power tool. The recycled cooling and rinsing fluid flows to the power tool via a supply line owing to the excess pressure.

Since the prior-art treatment apparatus suctions the soiled drilling fluid and feeds the cooling and rinsing fluid to the power tool in a closed circuit, it is necessary to adapt the control of the treatment apparatus to the power tool.

This control is carried out in another prior-art treatment apparatus by means of the starting current of the connected power tool. In order for the starting current of the power tool to be detected, the power tool has a safety plug that is plugged into the prior-art treatment apparatus and that supplies electricity to the power tool.

### SUMMARY OF THE INVENTION

A drawback of the known treatment apparatus is that it is not always possible to automatically control the treatment apparatus by means of the starting current of a connected power tool. Power tools that are configured, for instance, in the form of diamond-tipped core drills, are divided into various performance classes that entail different requirements regarding the electric supply of the power tools, and they have different electric connections and lines.

It is an object of the present invention to provide a treatment apparatus as well as a control method for a treatment apparatus of the above-mentioned type in such a way that the treatment apparatus can be automatically controlled for various battery-operated and/or mains-operated power tools.

The present invention provides an apparatus for treating a cooling and rinsing fluid stemming from a soiled drilling fluid, comprising a first container that collects the soiled drilling fluid, a second container that is connected to a discharge line for the treated cooling and rinsing fluid, a pressure switch that is arranged in the discharge line for purposes of measuring the pressure, and a control unit for switching the treatment apparatus over between a first mode of operation and at least one other mode of operation.

According to the invention, the treatment apparatus can be switched over between the first and the at least one other mode of operation as a function of the pressure measured in the discharge line.

Moreover, a method for controlling a treatment apparatus includes that the pressure switch measures the pressure in the discharge line and transmits a switching pulse to the control device whenever the pressure value exceeds a pre-set upper value or falls below a pre-set lower value.

Preferably, the control device switches the treatment apparatus over to a standby mode when the upper pressure value is exceeded, and over to a processing mode when the value falls below the lower pressure value.

Additional advantages as well as advantageous embodiments of the subject matter of the invention can be gleaned from the description, the drawing and the claims. Moreover, according to the invention, the features mentioned above and further elaborated upon can be used either on their own or in any desired combination. The embodiments shown and described should not be construed as a definitive compilation, but rather, they are provided by way of examples for purposes of illustrating the invention.

### BRIEF DESCRIPTION OF THE DRAWING

The following is shown:

FIG. 1: a core drill with a treatment apparatus according to the invention for purposes of treating a cooling and rinsing fluid.

### DETAILED DESCRIPTION

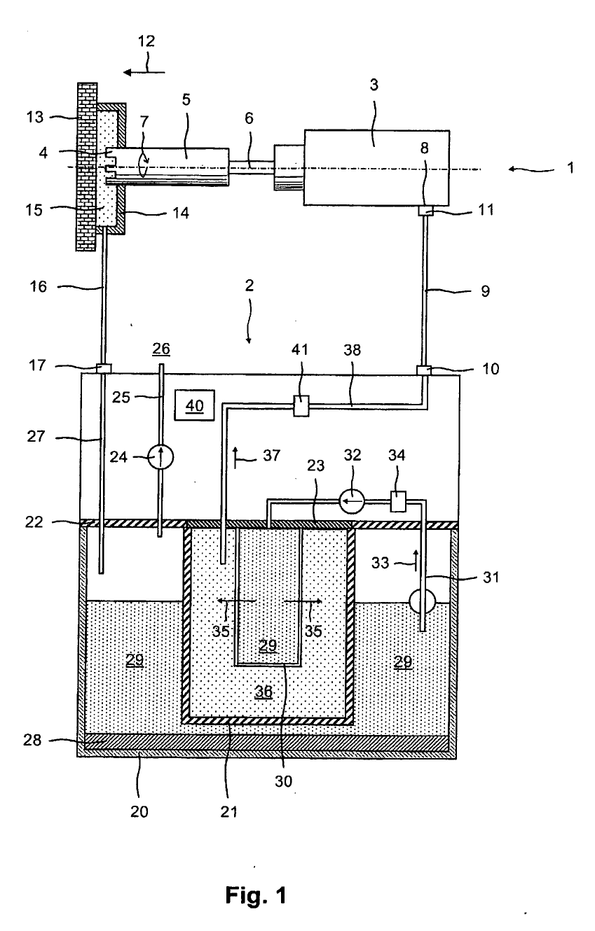

The power tool shown in FIG. 1 is configured as a core drill 1 that is connected to a treatment apparatus 2 according to the invention for purposes of treating a cooling and rinsing fluid.

The core drill 1 comprises a motor unit 3 that drives a core bit 5 having cutting segments 4 around a rotational axis 6 in a rotational direction 7. The cooling and rinsing fluid is fed to the motor unit 3 via an inlet opening 8. The inlet opening 8 is connected via a supply line 9 to an outlet pipe connection 10 of the treatment apparatus 2. As an alternative, the cooling and rinsing fluid can be fed to a suction head or rinsing head that is arranged downstream from the motor unit 3.

The throughput of the cooling and rinsing fluid into the motor unit 3 can be set by means of a regulating mechanism 11 that is connected to the inlet opening 8 of the motor unit 3 and that is manually operated by an operator. In this context, the regulating mechanism 11 is configured as a shut-off mechanism that can be set either to an open position in which the cooling and rinsing fluid can flow into the motor unit 3 or to a closed position in which the inflow of the cooling and rinsing fluid to the motor unit 3 is interrupted. As an alternative, the regulating mechanism 11 can allow a discrete or continuous adjustment of the throughput of the cooling and rinsing fluid between 0% (closed position) and 100% (open position).

During the drilling operation, that is to say, while the core bit 5 is being rotated around the rotational axis 6 and the cutting segments 4 are penetrating in the drilling direction 12 into a substrate 13 that is to be worked, the core bit 5 is rinsed and cooled by the cooling and rinsing fluid in the vicinity of the working site. A collecting device 14 that surrounds the working site is arranged on the substrate 13 that is to be worked and it serves to collect the heated up cooling and rinsing fluid laden with solids, which is then referred to as the soiled drilling fluid 15. The collecting device 14 is connected via a suction line 16 to an inlet pipe connection 17 of the treatment apparatus 2.

The treatment apparatus 2 comprises a first and a second container 20, 21. In order for the treatment apparatus 2 to have a compact configuration, the second container 21 is arranged in the first container 20, and both containers 20, 21 are each sealed air-tight and liquid-tight by means of a lid 22, 23, respectively. As an alternative, the two containers 20, 21 can be arranged next to each other.

During the drilling operation, the first container 20 cooperates with a suction device 24 that conveys the soiled drilling fluid 15 out of the collecting device 14 and into the first container 20. The suction device 24 is configured, for example, as a device for generating a negative pressure, which will be referred to below as a negative-pressure device, and the first container 20 is also referred to as a negative-pressure tank. The negative-pressure device 24 is arranged in a suction line 25, one end of which opens up into the negative-pressure tank 20, while its other end leads to the atmosphere 26. Due to the negative pressure that prevails in the negative-pressure tank 20 vis-è-vis the collecting device 14, the soiled drilling fluid 15 is conveyed into the negative-pressure tank 20 via the discharge line 16 and via a feed line 27 that is connected to one end of the inlet pipe connection 17 of the treatment apparatus 2 and that opens up with its other end into the negative-pressure tank 20.

The negative-pressure tank 20 additionally serves to pre-clean the soiled-fluid 15. Gravity causes the solids that are present in the soiled drilling fluid 15 and that stem from the material removed from the substrate 13 to settle as settled solids 28 at the bottom of the negative-pressure tank 20. A pre-cleaned soiled drilling fluid 29 is located above the settled solids 28.

In the second container 21, there is a filter element 30 that is connected via a connecting line 31 to the negative-pressure tank 20. In order to prevent the solids 28 that have settled due to gravity from getting into the filter element 30, the part of the connecting line 31 that extends into the negative-pressure tank 20 is configured as a riser pipe that is installed at a distance from the bottom of the negative-pressure tank 20. In the connecting line 31, there is a device for generating an excess pressure 32, which will be referred to below as an excess-pressure device and which is configured, for instance, as a hydraulic pump. The excess-pressure device 32 generates, for example, an excess pressure amounting to between 1 bar and 6 bar. The second container 21 is also referred to as an excess-pressure tank.

Due to the excess pressure, the pre-cleaned soiled drilling fluid 29 flows via the connecting line 31 out of the negative-pressure tank 20 and into the filter element 30. Upstream from the excess-pressure device 32 in the flow direction 33, there is a non-return valve 34 in the connecting line 31 that prevents the pre-cleaned soiled drilling fluid 29 from flowing back into the negative-pressure tank 20.

The excess pressure in the filter element 30 causes the pre-cleaned soiled drilling fluid 29 to flow through the filter element 30 in the flow direction 35 into the excess-pressure tank 21. Owing to gravity, the solids that are present in the pre-cleaned soiled drilling fluid 29 accumulate at the bottom of the filter element 30 or else are captured in the filter element 30. In the excess-pressure tank 21, recycled cooling and rinsing fluid 36 accumulates that can then be fed to the core drill 1 so that the circuit is closed. Owing to the pressure differential, the recycled cooling and rinsing fluid 36 flows in a flow direction 37 via the discharge line 38 whose one end opens up into the excess-pressure tank 21 while the other end is connected to the outlet pipe connection 10 of the treatment apparatus 2, and the supply line 9 opens up into the core drill 1.

The treatment apparatus 2 according to the invention can be run in different mode of operations. These include, among others, a processing mode in which the core drill 1 is supplied with recycled cooling and rinsing fluid 36 and the soiled drilling fluid 15 is simultaneously suctioned off at the collecting device 14, as well as a standby mode in which the treatment apparatus 2 is kept ready for operation.

The treatment apparatus 2 also has a control device 40 and a pressure switch 41. The control device 40 serves, among other things, to control the suction device 24 and the excess-pressure device 32. The pressure switch 41 measures the pressure in the discharge line 38 and transmits a switching pulse to the control unit 40 whenever the pressure value exceeds a pre-set upper value or falls below a pre-set lower value.

The operator sets the throughput of the cooling and rinsing fluid 36 to the core drill 1 by means of the regulating mechanism 11. In the processing mode, the regulating mechanism 11 is in the open position and the cooling and rinsing fluid 36 flows into the motor device 3 via the inlet opening 8. When the operator interrupts the work, he/she closes the regulating mechanism 11. Since the regulating mechanism 11 is closed, the feed of the cooling and rinsing fluid 36 to the motor unit 3 is interrupted. Excess pressure builds up in the discharge line 38 since the excess-pressure device 32 is still active.

If the pressure measured by the pressure switch 41 exceeds the pre-set, upper value for a certain time period, for instance, for 5 seconds, the control unit 40 switches the treatment apparatus 2 over to a standby mode for an undetermined period of time. The standby mode is characterized by the fact that the treatment apparatus 2 is kept ready for operation. The pressure switch 41 measures the pressure in the discharge line 38 at regular intervals. If the measured pressure falls below a pre-set value, the pressure switch 41 transmits a switching pulse to the control unit 40. The control unit 40 activates the excess-pressure device 32 until the pressure has reached the desired value. Once the desired pressure has been reached, the control device 40 deactivates the excess-pressure device 32.

The treatment apparatus 2 stays in the standby mode until the pressure switch 41 detects a pressure change in the discharge line 38. If the operator intends to continue the working procedure, he/she opens the regulating mechanism 11, which causes the pressure in the discharge line 38 to drop. The pressure switch 41 measures the pressure in the discharge line 38 and transmits a switching pulse to the control unit 40 if the pressure falls below a pre-set value. The control device 40 switches the treatment apparatus 2 from the standby mode over to the processing mode. This includes activating the excess-pressure device 32 and the suction device 24 so that the soiled drilling fluid 15 is suctioned by the suction device 24 via the suction line 16, and via the feed line 27 into the first container 20, and the treated cooling and rinsing 36 is fed to the motor unit 3 via the discharge line 38 and the supply line 9.

What is claimed is:

1. An apparatus for treating a cooling and rinsing fluid stemming from a soiled drilling fluid, comprising:
a first container collecting the soiled drilling fluid;
a second container connected to a discharge line for the treated cooling and rinsing fluid;
a pressure switch arranged in the discharge line for purposes of measuring the pressure; and
a control unit for switching the treatment apparatus over between a first mode of operation and at least one other mode of operation as a function of the pressure measured in the discharge line.

2. A method for controlling a treatment apparatus comprising:
measuring a pressure value in a discharge line with a pressure switch; and
transmitting a switching pulse to a control device whenever the pressure value exceeds a pre-set upper value or falls below a pre-set lower value.

3. The control method as recited in claim 2 wherein the control device switches the treatment apparatus over to a standby mode when the upper value is exceeded by the pressure value.

4. The control method as recited in claim 2 wherein the control device switches the treatment apparatus over to a processing mode when the pressure value falls below the lower value.
